(19) United States
(12) Patent Application Publication
(10) Pub. No.: US 2023/0373350 A1
(43) Pub. Date: Nov. 23, 2023

(54) THERMAL ENERGY MANAGEMENT SYSTEM AND METHOD FOR TRACTION BATTERY OF AN ELECTRIFIED VEHICLE

(71) Applicant: Ford Global Technologies, LLC, Dearborn, MI (US)

(72) Inventors: Hassan Farhat, Dearborn, MI (US); Ravi Gopal, Novi, MI (US)

(21) Appl. No.: 17/748,215

(22) Filed: May 19, 2022

(51) Int. Cl. B60L 58/26; B60L 53/10; B60L 50/64; B60L 58/27; H01M 10/613; H01M 10/615; H01M 10/625; H01M 10/6567

(52) U.S. Cl. CPC B60L 58/26; B60L 53/11; B60L 50/64; B60L 58/27; H01M 10/613; H01M 10/615; H01M 10/625; H01M 10/6567; H01M 2220/20

(57) ABSTRACT

A thermal energy management method for an electrified vehicle includes heating a plurality of thermal batteries within an electrified vehicle, cooling a first thermal battery of the plurality of thermal batteries. After cooling the first thermal battery, the method cools a second thermal battery of the plurality of thermal batteries.

### TECHNICAL FIELD

This disclosure relates generally to managing thermal energy within an electrified vehicle and, more particularly, to managing the thermal energy generated when the vehicle is fast charging.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery can power the electric machines.

Thermal batteries can passively store and release thermal energy. Thermal batteries include adsorption thermal batteries and phase-change thermal batteries.

### SUMMARY

In some aspects, the techniques described herein relate to a thermal energy management method for an electrified vehicle, including: heating a plurality of thermal batteries within an electrified vehicle; cooling a first thermal battery of the plurality of thermal batteries; after cooling the first thermal battery, cooling a second thermal battery of the plurality of thermal batteries.

In some aspects, the techniques described herein relate to a method, wherein heating the plurality of thermal batteries includes simultaneously heating the first and second thermal batteries.

In some aspects, the techniques described herein relate to a method, further including heating the plurality of thermal batteries using thermal energy generated when charging a traction battery of the electrified vehicle.

In some aspects, the techniques described herein relate to a method, wherein the charging is a DC fast charging.

In some aspects, the techniques described herein relate to a method, further including communicating a coolant from a traction battery to both the first and second thermal batteries when heating the first and second thermal batteries.

In some aspects, the techniques described herein relate to a method, further including directing a coolant through the first thermal battery when cooling the first thermal battery, and, redirecting the coolant through the second thermal battery when cooling the second thermal battery.

In some aspects, the techniques described herein relate to a method, further including redirecting the coolant by actuating a valve.

In some aspects, the techniques described herein relate to a method, directing the coolant from the first thermal battery to a refrigerant system when cooling the first thermal battery.

In some aspects, the techniques described herein relate to a method, cooling the first thermal battery and the second thermal battery using a low temperature loop heat exchanger when feasible. This can, in some examples, reduces the dependency on the chiller subloop.

In some aspects, the techniques described herein relate to a method, wherein the first and second thermal batteries are first and second phase-change batteries.

In some aspects, the techniques described herein relate to a method further including, using thermal energy stored in the thermal battery to heat a traction battery. Heating the traction battery when known through vehicle connectivity that heating the traction battery by next morning is needed. This can, in some examples, reduce the dependency on the heating subloop.

In some aspects, the techniques described herein relate to a thermal energy management system for an electrified vehicle, including: a thermal battery assembly having at least a first thermal battery and a second thermal battery; a traction battery, the first and second thermal batteries configured to simultaneously receive coolant from the traction battery to cool the traction battery; and a chiller, the chiller configured to sequentially receive coolant from the first thermal battery and then the second thermal battery to cool the first and second thermal batteries sequentially.

In some aspects, the techniques described herein relate to a system, wherein the first and second thermal batteries are adsorption thermal batteries.

In some aspects, the techniques described herein relate to a method further including, augmenting the thermal energy stored in the thermal battery with energy from the PTC heater via high temperature loop heat exchanger to preheat a traction battery.

In some aspects, the techniques described herein relate to a system, further including at least one valve that is actuated to selectively direct coolant from the first thermal battery or the second thermal battery to the chiller.

In some aspects, the techniques described herein relate to a system, wherein the chiller transfers thermal energy from the coolant to a refrigerant fluid within a heating ventilation and air conditioning system of the electrified vehicle.

In some aspects, the techniques described herein relate to a system, wherein the thermal battery assembly is configured to cool the traction battery during a DC fast charge of the traction battery in conjunction with the vehicle cooling system.

In some aspects, the techniques described herein relate to a system, wherein the thermal battery assembly includes at least one third thermal battery.

In some aspects, the techniques described herein relate to a system, wherein the first thermal battery is separate and distinct from the second thermal battery.

In some aspects, the techniques described herein relate to a system, further including a manifold configured to direct the coolant from the traction battery to the first thermal battery and the second thermal battery.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery.

FIG. 2 illustrates a schematic view of a powertrain, traction battery, and thermal management system from the vehicle of FIG. 1 according to an exemplary embodiment of the present disclosure.

FIG. 3 illustrates the thermal management system of FIG. 2 when cooling the first thermal battery of the thermal management system.

FIG. 4 illustrates the thermal management system of FIG. 2 when cooling the second thermal battery.

FIG. 5 illustrates a method of selecting an operational Mode for the thermal management system.

FIGS. 6-14 each schematically illustrate exemplary operational Modes for a thermal management system according to an exemplary embodiment.

### DETAILED DESCRIPTION

This disclosure details exemplary methods and systems for managing thermal energy within a traction battery of an electrified vehicle, particularly during a fast charge of the traction battery.

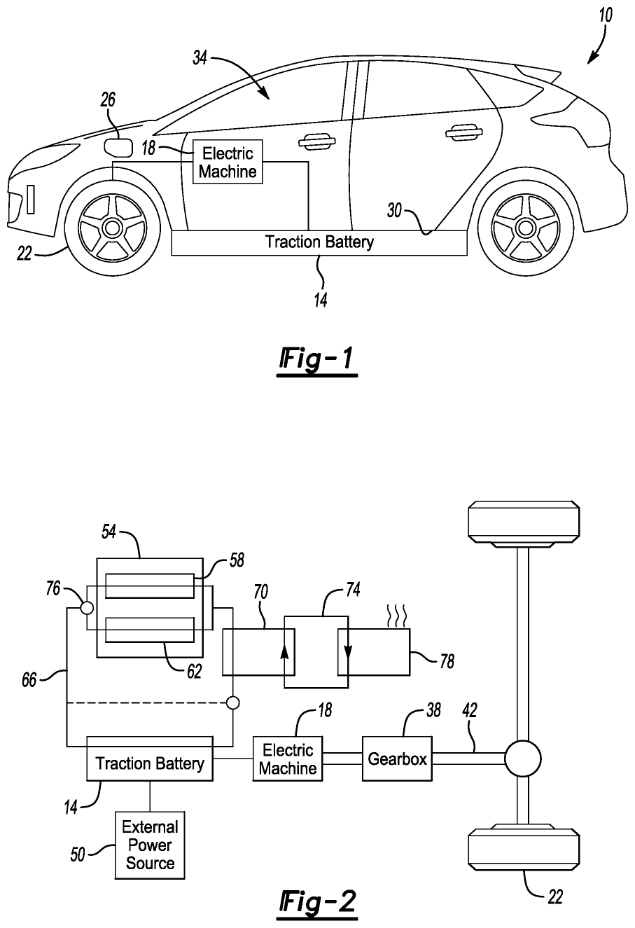

With reference to FIG. 1, an electrified vehicle 10 includes a traction battery 14, an electric machine 18, wheels 22, and a charge port 26.

The example electrified vehicle 10 is an all-electric vehicle. In other examples, the electrified vehicle 10 is a hybrid-electric vehicle, which can selectively drive the wheels 22 utilizing torque provided by an internal combustion engine instead of, or in addition to, an electric machine. Generally, the electrified vehicle 10 can be any type of vehicle having a traction battery.

The traction battery 14 can electrically power the electric machine 18, which converts electrical power to torque to drive the wheels 22. To recharge the traction battery 14, the electrified vehicle 10 can be electrically coupled to an external power source through the charge port 26.

The traction battery 14 can be recharged from the external power source. In this example, the traction battery 14 is secured adjacent an underbody 30 of the electrified vehicle 10 beneath the passenger compartment 34 of the electrified vehicle 10.

The traction battery 14 can be a high-voltage traction battery pack that includes one or more individual battery arrays (i.e., battery assemblies or groupings of individual battery cells) capable of outputting electrical power to operate the electric machine and/or other electrical loads of the electrified vehicle 10. Other types of energy storage devices and/or output devices can instead or additionally be used to electrically power the electrified vehicle.

With reference now to FIG. 2 and continuing reference to FIG. 1, the example electric machine 18 is coupled to a gearbox 38 that can adjust an output torque and speed of the electric machine 18 by a predetermined gear ratio. The gearbox 38 can be operably connected to the wheels 22 via an output shaft 42.

In the example of FIG. 2, the traction battery 14 is operably coupled to an external power source 50 that recharges the traction battery 14 via a DC fast-charge. When charging, the traction battery 14 and surrounding components can generate thermal energy.

To cool the traction battery 14, the electrified vehicle 10 incorporates a thermal battery assembly 54, a first thermal battery 58 of the assembly 54, a second thermal battery 62 of the assembly 54, a coolant loop 66, and a thermal energy exchanger—here a chiller 70. The first thermal battery 58 is separate and distinct from the second thermal battery 62. The first thermal battery 58 and the second thermal battery 62 can be adsorption thermal batteries or phase-change thermal batteries, for example. If phase-change thermal batteries, the phase-change material can be an organic material having a phase-change temperature of 35 degrees Celsius. The first thermal battery 58 and the second thermal battery 62 can have an optimized adsorbent such as metal organic framework having a desorption temperature that is greater than or equal to 35 degrees Celsius and an adsorption temperature that is less than or equal to 30 degrees Celsius.

As the traction battery 14 is recharged from the external power source 50, a coolant can flow along the coolant loop 66 that extends between the traction battery 14 and the thermal battery assembly 54. The coolant transfers some thermal energy from the traction battery 14 to the first thermal battery 58 and the second thermal battery 62 of the thermal battery assembly 54. The thermal battery assembly 54 stores the thermal energy. The coolant then flows along the coolant loop 66 from the thermal battery assembly 54 to the chiller 70. The coolant transfers some thermal energy from the traction battery 14 to the chiller 70.

At the chiller 70, additional thermal energy within the coolant is, in this example, transferred to a refrigerant loop 74 and then released to air within a refrigerant system 78. The refrigerant loop 74 and system 78 can be part of a Heating Ventilation and Air Conditioning (HVAC) system for the electrified vehicle 10.

From the chiller 70, the coolant flows back to the traction battery 14 to take on more thermal energy from the traction battery 14 as the traction battery 14 continues to charge from the external power source 50.

After charging the traction battery 14, the electrified vehicle 10 is decoupled from the external power source 50. During the charging, cooling the traction battery 14 with the thermal battery assembly 54 effectively heated the first thermal battery 58 and the second thermal battery 62. The first thermal battery 58 and the second thermal battery 62 retain this thermal energy after the charging. The first thermal battery 58 and the second thermal battery 62 can be insulated to reduce or eliminate thermal energy dissipation to ambient. This can be useful if thermal energy from the first thermal battery 58 and the second thermal battery 62 is required to heat the traction battery 14.

This disclosure relates generally to removing thermal energy from the first thermal battery 58 and the second thermal battery 62 after charging the traction battery 14 so that, among other things, the thermal battery assembly 54 is prepared to take on more thermal energy during a subsequent DC fast charge of the traction battery 14.

In particular, an exemplary embodiment of this disclosure details using a refrigerant system to sequentially cool the first thermal battery 58 and then the second thermal battery 62. The refrigerant system can advantageously be sized to cool the first thermal battery 58 or the second thermal battery 62 rather than needing to be sized to cool the entire thermal battery assembly 54.

In this example, the first thermal battery 58 and the second thermal battery 62 are sized to have a half cycle (i.e., melting time for phase change battery or desorbing the adsorbate [commonly water] for adsorption battery) that is equal, or nominally equal, to a time required to fast-charge the traction battery 14. Sequentially cooling the first thermal battery 58 and then the second thermal battery 62 can facilitate use of a smaller refrigerant system than if a single large thermal battery were used instead of the first thermal battery 58 and the second thermal battery 62.

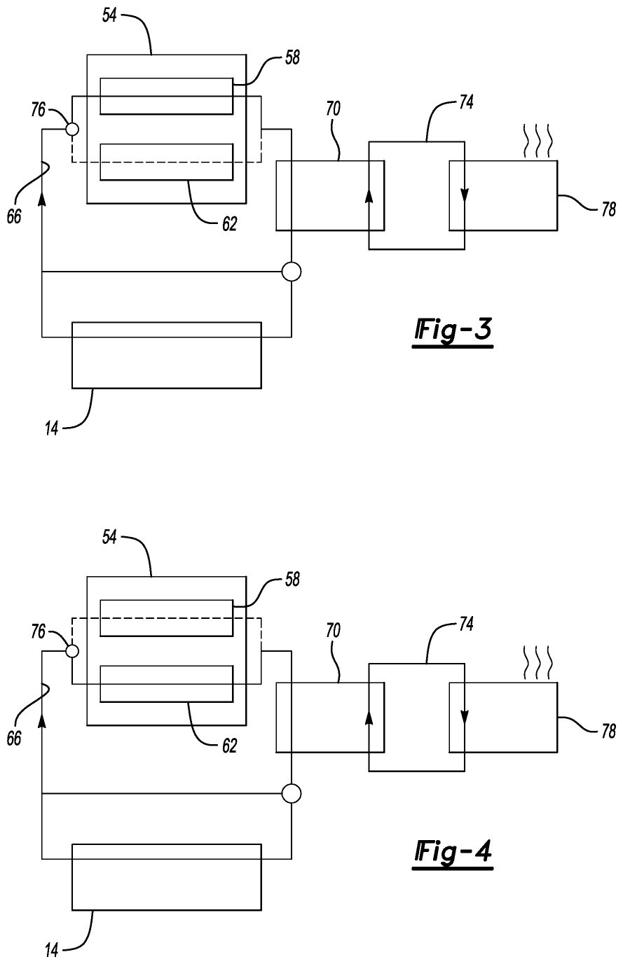

FIG. 3 shows the coolant loop 66 when the refrigerant loop 74 is used to transfer thermal energy from the first thermal battery 58 after the electrified vehicle 10 is decoupled from the external power source 50. In this example, the refrigerant loop 74 is used to transfer thermal energy from the first thermal battery 58 as the electrified vehicle 10 is being driven during a drive cycle and, for example, when maximum A/C is not required. Thermal energy from the first thermal battery 58 is transferred to the refrigerant within the refrigerant loop 74. Thermal energy then transfers away from the refrigerant at the refrigerant system 78.

As shown in FIG. 4, after cooling the first thermal battery 58, the coolant loop 66 can rerouted through the second thermal battery 62, but not the first thermal battery 58. A valve can be adjusted to reroute the coolant loop 66 in this way.

In this example, another proportional valve is adjusted so that the coolant flows around the traction battery 14 when the refrigerant loop 74 is cooling the first thermal battery 58 or the second thermal battery 62.

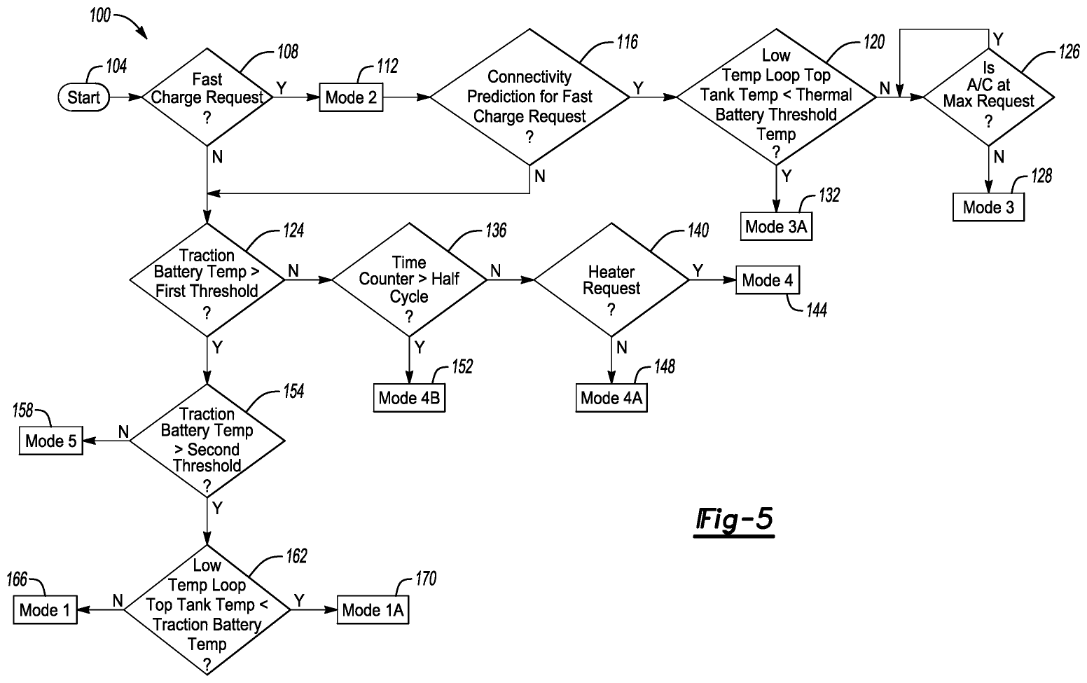

With reference now to FIG. 5 and continuing reference to FIGS. 1 and 2, an operating mode selection method 100 can be utilized to select a particular operational mode for how the thermal battery assembly 54 can be operated to manage thermal energy within the electrified vehicle 10.

The method 100 begins at a start 104. Next, at a step 108, the method 100 assesses whether a request to DC fast-charge the electrified vehicle 10 has been received.

If yes, the method 100 moves to a step 112 where Mode 2 is executed. After executing Mode 2, the method 100 moves from the step 112 to a step 116, which predicts through vehicle connectivity a need for a fast-charge request. If a fast charge is predicted, the method 100 moves from the step 116 to a step 120. If a fast charge is not predicted at the step 116, the method 100 moves from the step 116 to a step 124. Vehicle connectivity via the internet can allows the electrified vehicle 10 to predict by mapping the route (hills, valleys, time to get to target) whether fast recharge is expected before reaching a destination, and thus command cooling of the thermal batteries to prepare. Connectivity with weather forecast also allow the system to predict whether heating of the traction battery may be needed the following morning so the stored energy in the thermal batteries may be kept and used to warm the traction battery in the following morning.

At the step 120, the method 100 assesses whether a low temperature loop top tank temperature is less than a thermal battery threshold temperature. The low temperature loop can be a cooling loop used for cooling the electric machine 18, an inverter, DC to DC converters, etc. If no, the method 100 moves from the step 120 to a step 126, which asked if an air conditioning requests is at the max. If no, the method 100 moves from the step 126 to a step 128 where Mode 3 is executed. If, at the step 120, the low temp loop top tank temperature is less than a thermal battery threshold temperature, the method 100 moves to a step 132 and executes a Mode 3A. If no fast-charge is requested at the step 108, or there is no prediction from the electrified vehicle 10 connectivity for a fast-charge request at the step 116, the method 100 moves to a step 124.

At the step 124, the method 100 assesses whether or not a temperature of the traction battery 14 is greater than a first threshold temperature. If no, the method 100 moves from the step 124 to a step 136, which assesses whether a time counter is greater than a half-cycle. If the time counter is not greater than a half-cycle at the step 136, the method 100 moves from the step 136 to the step 140, which assesses whether or not there has been a heater request. The time counter starts counting time from a start of cooling the a thermal battery.

If there has been a heater request, the method 100 executes Mode 4A at a step 148. If no heater is requested at the step 140, the method 100 executes Mode 4 at step 144.

Returning to the step 136, if the time counter is greater than a half-cycle, the method 100 moves to a step 152 that executes utilizes Mode 4B.

Returning to the step 124, if the traction battery temperature is greater than a first threshold, the method 100 moves from the step 124 to a step 154, which assesses whether or not the traction battery temperature is greater than a second threshold. If no, the method 100 moves from the step 154 to a step 158 where Mode 5 is executed. If the traction battery temperature is greater than the second threshold at the step 154, the method 100 moves from the step 154 to a step 162, which assesses whether a low temperature loop top tank temperature is less than a temperature of the traction battery. If no, the method 100 moves to a step 166 and selects Mode 1. If yes, the method 100 moves to a step 170 and selects a Mode 1A.

FIGS. 6-15 schematically illustrates details of the various exemplary control modes used in connection with a thermal management system having a variation of the thermal battery assembly shown in FIGS. 2-4.

The thermal management system of FIGS. 6-15 includes the first thermal battery 58, the second thermal battery 62, the traction battery 14, the coolant loop 66, the chiller 70, the refrigerant loop 74, and the refrigerant system 78. The thermal management assembly of FIGS. 6-15 additionally includes a manifold 80, valves 82, 86, 88, 90, a pump 92, a first heat exchanger 94, a second heat exchanger 96, and at least one third thermal battery 98.

The valves 82 and 88 are three-way valves. The valve 86 is a four-way valve. The valve 90 may be a five-way valve. The pump 92 can circulates the coolant along the coolant loop 66 during the various modes.

FIG. 6 shows the Mode 1 where the valve 82 and the valve 86 are adjusted so that coolant moves along the coolant loop 66 from the traction battery 14 to the chiller 70 without passing through any of the thermal batteries 58, 62, or 98. The traction battery 14 is cooled by the refrigerant loop 74. In this example, the net heat dissipation from the traction battery 14 during the Mode 1 can be for example 3 kW, and the refrigerant system capacity can be −3 kW at partial capacity.

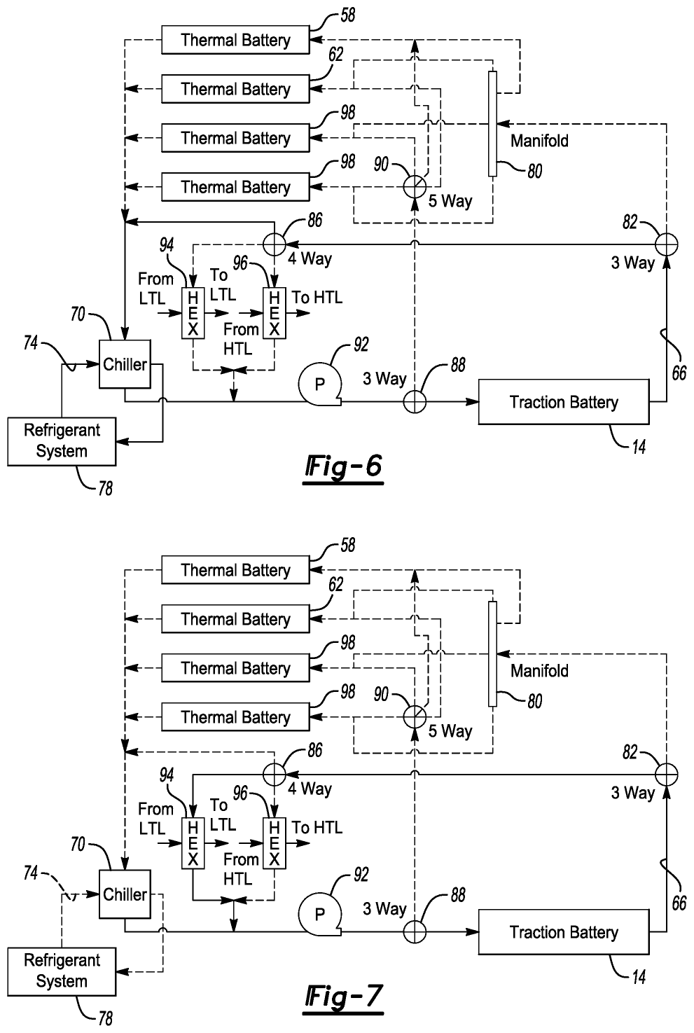

FIG. 7 shows the Mode 1A where the valve 86 is adjusted to direct coolant through the first heat exchanger 94 and then back to the traction battery 14. The traction battery 14 is cooled by the first heat exchanger 94. In this example, the net heat dissipation from the traction battery 14 during the Mode 1A can be 3 kW, and the low temperature loop liquid-to-liquid (LTL) heat exchanger capacity can be −3 kW.

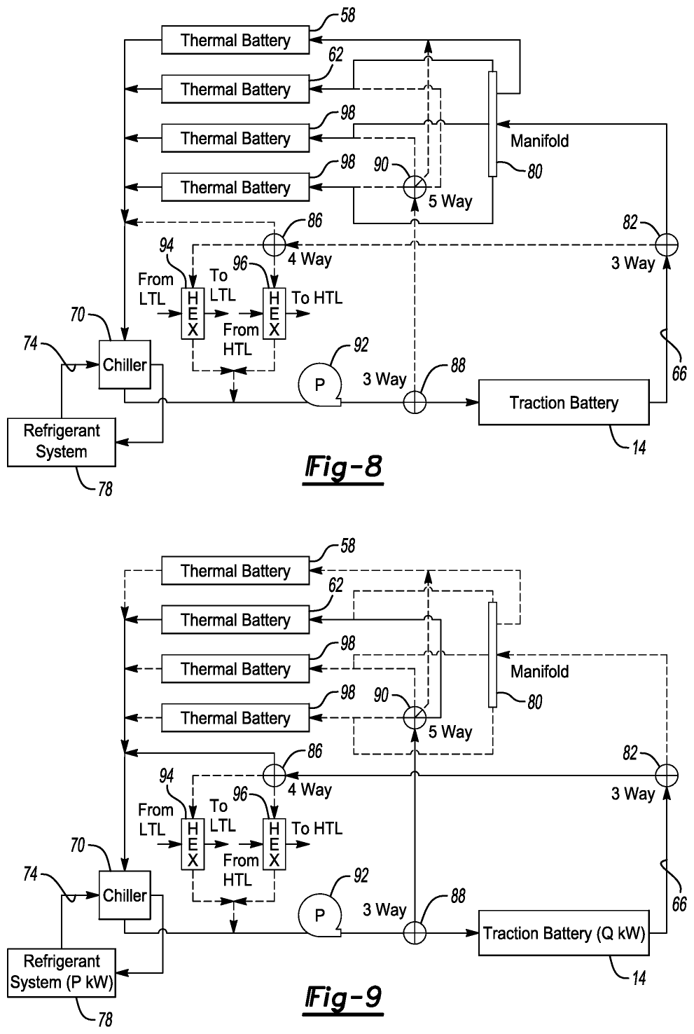

FIG. 8 shows the Mode 2 where the valve 82 is actuated so that coolant from the traction battery 14 is communicated into the manifold 80 and then simultaneously through the first thermal battery 58, the second thermal battery 62, and at least one third thermal battery 98. The coolant moves from the thermal batteries 58, 62, 98, to the chiller 70. In this example, the net heat dissipation from the traction battery 14 during the Mode 2 where the traction battery 14 is fast charging can be for example 18 kW, and a capacity of each thermal battery 58, 62, and 98 can be −3 kW for a total thermal battery capacity of, in this example where there are four total thermal batteries, −12 kW. The refrigerant system capacity can be for example −6 kW at its maximum capacity.

FIG. 9 shows the Mode 3 where the valve 88 is actuated to redirect some coolant that has passed through the chiller 70 through one of the thermal batteries 58, 62, or 98. In this example, the coolant is directed by the valve 90 through the second thermal battery 62, but not the first thermal battery 58 or the at least one third thermal battery 98. In this example, the net heat dissipation from the traction battery 14 during the Mode 3 can be for example 3 kW, and the refrigerant system maximum capacity can be −6 kW. The capacity of each thermal battery 58, 62, and 98 can be 3 kW.

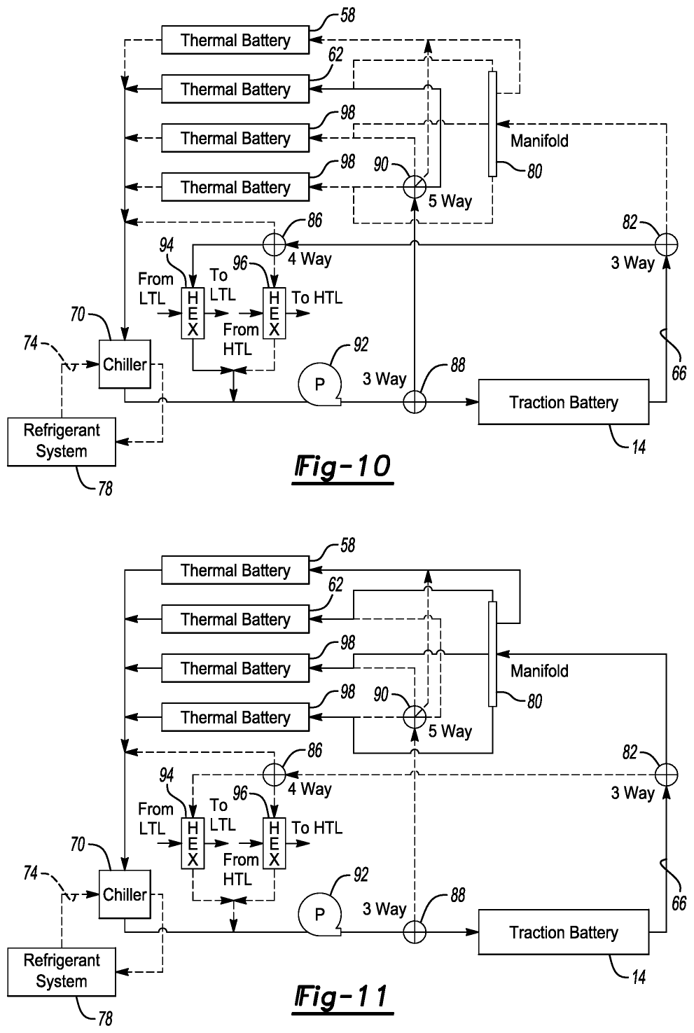

FIG. 10 shows the Mode 3A where the valve 86 is actuated from Mode 3 to direct the coolant to the first low temperature loop (LTL) heat exchanger 94 rather than to the chiller 70. From heat exchanger 94 and chiller 70, the coolant moves through the valve 88 to one of the thermal batteries 58, 62, or 98. In this example, the net heat dissipation from the traction battery 14 during the Mode 3A can be for example 3 kW, and the low temperature loop heat liquid-to-liquid heat exchanger capacity can be −6 kW. The capacity of each thermal battery 58, 62, and 98 can be 3 kW. In this mode the refrigerant system is turned off and the ambient temperature is low.

FIG. 11 shows the Mode 4, which heats the traction battery 14 by actuating the valves 82, 86, 88, 90 to direct coolant through the manifold 80 and then, simultaneously, through the first thermal battery 58, the second thermal battery 62, and the at least one third thermal battery 98. Mode 4 differs from the Mode 2 described in connection with FIG. 9 in that the chiller 70 is not utilized to remove additional thermal energy from the coolant after passing through the thermal batteries 58, 62, and 98. In this example, the net heat dissipation from the traction battery 14 during the Mode 3 and during operation of the traction battery 14 can be for example 0.5 kW, and the capacity of each thermal battery 58, 62, and 98 can be 3 kW.

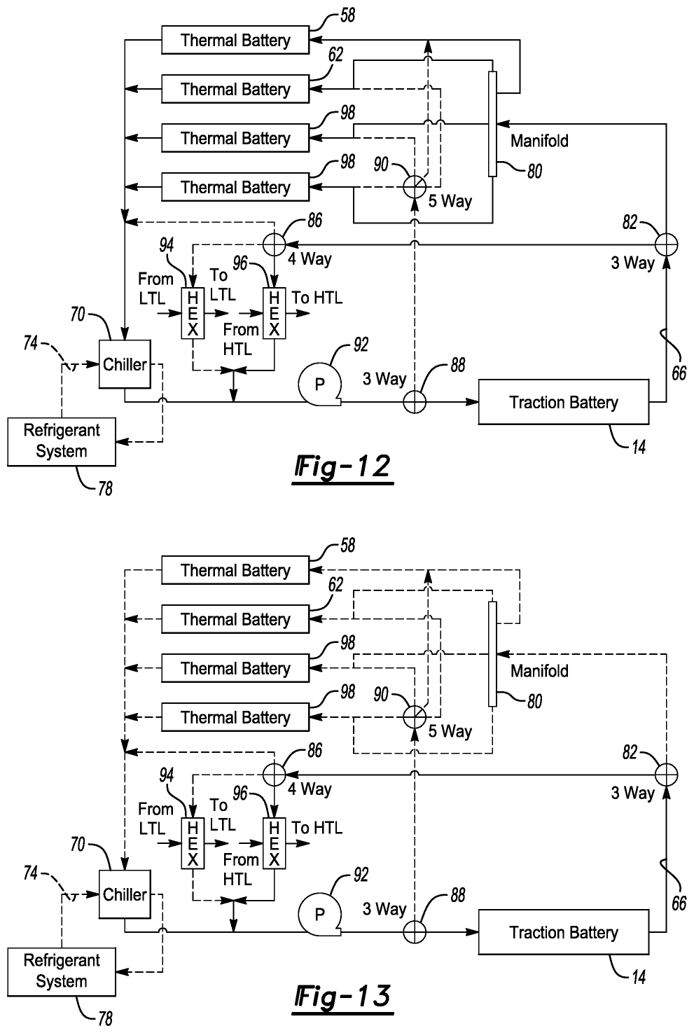

FIG. 12 shows the Mode 4A, which heats the traction battery is similar to the Mode 4 but actuates the three-way valve 82 and the four-way valve 86 to direct at least some of the coolant around the thermal batteries 58, 62, 98 and through the second high temperature loop liquid-to-liquid heat exchanger 96 if heat is available via the high temperature loop or PTC heater. In this example, the net heat dissipation from the traction battery 14 during the Mode 4A and during operation of the traction battery 14 can be for example 0.5 kW, and the capacity of each thermal battery 58, 62, and 98 can be 3 kW, and a capacity of the high temperature loop liquid-to-liquid heat exchanger can be 3 kW.

FIG. 13 shows the Mode 4B where the three-way valve 82 and the four-way valve 86 are actuated to direct all the coolant away from the thermal batteries 58, 62, 98 and through the heat exchanger 96. In this example, the net heat dissipation from the traction battery 14 during the Mode 4B and during operation of the traction battery 14 can be for example 0.5 kW, and a capacity of the HTL heat exchanger can be 3 kW. This mode can be exercised only if heating is needed beyond the thermal battery half cycle and if heat is available through the high temperature loop or through the PTC heater.

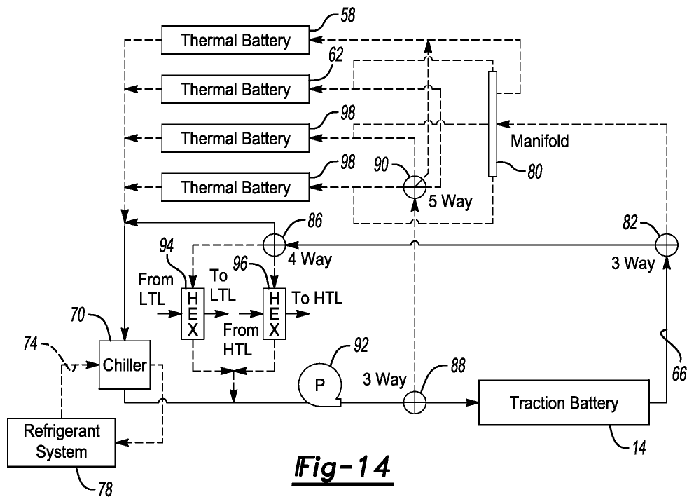

FIG. 14 shows the Mode 5 where the three-way valve 82 and the four-way valve 86 are actuated to direct all the coolant through the chiller 70 while the refrigerant system is turned off. In this example, the net heat dissipation from the traction battery 14 during the Mode 5 and during operation of the traction battery 14 can be for example 0.5 kW, however the battery temperature is within a range that does not require cooling nor heating.

Features of the discloses examples include a thermal management system for a battery that can provide thermal management during a charge of the traction battery utilizing thermal batteries. The thermal batteries, after cooling the traction battery, are cooled sequentially so that components associated and utilized for cooling the thermal batteries can be sized for regular vehicle cabin and battery cooling requirements and are not oversized since the system is designed with relatively small thermal batteries that are sequentially cooled when no maximum A/C is required.

The preceding description is exemplary rather than limiting in nature. Variations modifications to the disclosed examples may become apparent to those skilled in the art that do not necessarily depart from the essence of this disclosure. Thus, the scope of protection given to this disclosure can only be determined by studying the following claims.

What is claimed is:

1. A thermal energy management method for an electrified vehicle, comprising:
heating a plurality of thermal batteries within an electrified vehicle;
cooling a first thermal battery of the plurality of thermal batteries;
after cooling the first thermal battery, cooling a second thermal battery of the plurality of thermal batteries.

2. The method of claim 1, wherein heating the plurality of thermal batteries includes simultaneously heating the first and second thermal batteries.

3. The method of claim 1, further comprising heating the plurality of thermal batteries using thermal energy generated when charging a traction battery of the electrified vehicle.

4. The method of claim 3, wherein the charging is a DC fast charging.

5. The method of claim 1, further comprising communicating a coolant from a traction battery to both the first and second thermal batteries when heating the first and second thermal batteries.

6. The method of claim 1, further comprising directing a coolant through the first thermal battery when cooling the first thermal battery, and, redirecting the coolant through the second thermal battery when cooling the second thermal battery.

7. The method of claim 6, further comprising redirecting the coolant by actuating a valve.

8. The method of claim 6, directing the coolant from the first thermal battery to a refrigerant system when cooling the first thermal battery.

9. The method of claim 1, further comprising cooling the first thermal battery and the second thermal battery using a low temperature loop heat exchanger.

10. The method of claim 1, wherein the first and second thermal batteries are first and second phase-change batteries.

11. The method of claim 1, further comprising, using thermal energy stored in the thermal battery to heat a traction battery.

12. A thermal energy management system for an electrified vehicle, comprising:
a thermal battery assembly having at least a first thermal battery and a second thermal battery;
a traction battery, the first and second thermal batteries configured to simultaneously receive coolant from the traction battery to cool the traction battery; and
a chiller, the chiller configured to sequentially receive coolant from the first thermal battery and then the second thermal battery to cool the first and second thermal batteries.

13. The system of claim 12, wherein the first and second thermal batteries are adsorption thermal batteries.

14. The system of claim 12, wherein the first and second thermal batteries are first and second phase-change thermal batteries.

15. The system of claim 12, further comprising at least one valve that is actuated to selectively direct coolant from the first thermal battery or the second thermal battery to the chiller.

16. The system of claim 12, wherein the chiller transfers thermal energy from the coolant to a refrigerant system within a HVAC system of the electrified vehicle.

17. The system of claim 12, wherein the thermal battery assembly is configured to cool the traction battery during a DC fast charge of the traction battery.

18. The system of claim 12, wherein the thermal battery assembly includes at least one third thermal battery.

19. The system of claim 12, wherein the first thermal battery is separate and distinct from the second thermal battery.

20. The system of claim 12, further comprising a manifold configured to direct the coolant from the traction battery to the first thermal battery and the second thermal battery.
